(19) United States
(12) Patent Application Publication
(10) Pub. No.: US 2026/0066378 A1
(43) Pub. Date: Mar. 5, 2026

(54) ENERGY STORAGE DEVICE AND CONTROL METHOD FOR COOLING ENERGY STORAGE DEVICE

(71) Applicant: SAMSUNG SDI CO., LTD., Yongin-si (KR)

(72) Inventors: DONGSEOK IN, Yongin-si (KR); Daae Kim, Yongin-si (KR); Jinbeom Kim, Yongin-si (KR)

(21) Appl. No.: 19/063,596

(22) Filed: Feb. 26, 2025

(30) Foreign Application Priority Data
Sep. 2, 2024 (KR) 10-2024-0118749

(51) Int. Cl. H01M 10/633; H01M 10/48; H01M 10/613; H01M 10/635; H01M 10/6569

(52) U.S. Cl. CPC H01M 10/633; H01M 10/486; H01M 10/613; H01M 10/635; H01M 10/6569

(57) ABSTRACT

A control method for cooling an energy storage device, the control method including obtaining, by a battery management system (BMS), outside air temperature data, charge rate setting data, and noise limit criteria data associated with an energy storage device including a plurality of battery cells, calculating, by the BMS, a first control value for controlling a cooling unit of the energy storage device based on the outside air temperature data and the charge rate setting data, calculating, by the BMS, a second control value for controlling the cooling unit based on the noise limit criteria data, determining, by the BMS, a final control value based on the first control value and the second control value, and outputting, by the BMS, the determined final control value.

### CROSS-REFERENCE TO RELATED APPLICATION

The present application claims priority to and the benefit of Korean Application No. 10-2024-0118749, filed on Sep. 2, 2024, in the Korean Intellectual Property Office, the entire disclosure of which is incorporated by reference herein.

### BACKGROUND

### 1. Field

Embodiments relate to an energy storage device and control method for cooling the energy storage device.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a control method for cooling an energy storage device, the control method including obtaining, by a battery management system (BMS), outside air temperature data, charge rate setting data, and noise limit criteria data associated with an energy storage device including a plurality of battery cells, calculating, by the BMS, a first control value for controlling a cooling unit of the energy storage device based on the outside air temperature data and the charge rate setting data, calculating, by the BMS, a second control value for controlling the cooling unit based on the noise limit criteria data, determining, by the BMS, a final control value based on the first control value and the second control value, and outputting, by the BMS, the determined final control value.

Determining the final control value may include detecting a temperature of each of the plurality of battery cells included in the energy storage device, and determining the first control value as the final control value if a temperature of at least one battery cell of the plurality of battery cells exceeds a first threshold or a rise rate of the temperature exceeds a second threshold.

Outputting the final control value may include outputting a reset request for a parameter associated with the second control value.

Determining the final control value may include detecting a temperature of each of the plurality of battery cells included in the energy storage device, comparing the first control value with the second control value if the temperature of each of the plurality of battery cells is lower than or equal to a first threshold and a rise rate of the temperature is lower than or equal to a second threshold, and determining the first control value as the final control value if it is determined that the first control value exceeds the second control value.

Outputting the final control value may include outputting a reset request for a parameter associated with the first control value.

Determining the final control value may further include transmitting, by the BMS, the second control value to the cooling unit if it is determined that the first control value is lower than or equal to the second control value, determining, by the cooling unit, a third control value based on the second control value and an operable range of the cooling unit, and determining, by the BMS, the third control value as the final control value.

Determining the third control value may include detecting an outflow temperature of a cooling fluid flowing through a cooling flow path of the cooling unit, detecting a pressure of a refrigerant cooling the cooling fluid in a condenser of the cooling unit, and determining the second control value as the third control value if the outflow temperature of the cooling fluid is lower than or equal to a third threshold and the pressure of the refrigerant is lower than or equal to a fourth threshold.

Outputting the final control value may include outputting a control request for the cooling unit based on the final control value.

Determining the third control value may further include calculating a fourth control value based on the outflow temperature of the cooling fluid and the pressure of the refrigerant if the outflow temperature of the cooling fluid exceeds the third threshold or the pressure of the refrigerant exceeds the fourth threshold, and determining the fourth control value as the third control value.

Outputting the final control value may include outputting a reset request for a parameter associated with the first control value.

Determining the third control value may further include at least one of detecting a temperature rise rate of the cooling fluid, and detecting a temperature of the refrigerant.

The first control value may include a maximum speed control value for a condenser fan included in the cooling unit.

The outside air temperature data may be measured near a condenser of the cooling unit.

Embodiments include an energy storage device, including a plurality of battery cells, a cooling unit configured to cool the plurality of battery cells, and a BMS configured to control the cooling unit, wherein the BMS is configured to obtain outside air temperature data, charge rate setting data, and noise limit criteria data associated with an energy storage device, calculate a first control value for controlling the cooling unit based on the outside air temperature data and the charge rate setting data, calculate a second control value for controlling the cooling unit based on the noise limit criteria data, determine a final control value based on the first control value and the second control value, and output the final control value.

Determining the final control value may include detecting, by the BMS, a temperature of each of the plurality of battery cells, and determining, by the BMS, the first control value as the final control value if a temperature of at least one battery cell of the plurality of battery cells exceeds a first threshold or a rise rate of the temperature exceeds a second threshold.

Determining the final control value may include detecting, by the BMS, a temperature of each of the plurality of battery cells, comparing, by the BMS, the first control value with the second control value if the temperature of each of the plurality of battery cells is lower than or equal to a first threshold and a rise rate of the temperature is lower than or equal to a second threshold, and determining, by the BMS, the first control value as the final control value if it is determined that the first control value exceeds the second control value.

Determining the final control value may further include transmitting, by the BMS, the second control value to the cooling unit if it is determined that the first control value is lower than or equal to the second control value, determining, by the cooling unit, a third control value based on the second control value and an operable range of the cooling unit, and determining, by the BMS, the third control value as the final control value.

Determining the third control value may include detecting, by the cooling unit, an outflow temperature of a cooling fluid flowing through a cooling flow path of the cooling unit, detecting, by the cooling unit, a pressure of a refrigerant cooling the cooling fluid in a condenser of the cooling unit, and determining, by the cooling unit, the second control value as the third control value if the outflow temperature of the cooling fluid is lower than or equal to a third threshold and the pressure of the refrigerant is lower than or equal to a fourth threshold.

Determining the third control value may further include calculating, by the cooling unit, a fourth control value based on the outflow temperature of the cooling fluid and the pressure of the refrigerant if the outflow temperature of the cooling fluid exceeds the third threshold or the pressure of the refrigerant exceeds the fourth threshold, and determining, by the cooling unit, the fourth control value as the third control value.

Determining the third control value may further include at least one of detecting, by the cooling unit, a temperature rise rate of the cooling fluid, and detecting, by the cooling unit, a temperature of the refrigerant.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

Features will become apparent to those of ordinary skill in the art by describing in detail exemplary embodiments with reference to the attached drawings, in which:

FIG. 1 is a block diagram showing the configuration of an energy storage device according to one or more embodiments of the present disclosure;

FIG. 2 is a diagram for describing a control method for cooling an energy storage device performed between a customer and a BMS according to one or more embodiments of the present disclosure;

FIG. 3 is a diagram for describing an output procedure of a final control value of a control method for cooling an energy storage device performed between a customer, a BMS, and a cooling unit according to one or more embodiments of the present disclosure;

FIG. 4 is a diagram for describing an output procedure of a final control value of a control method for cooling an energy storage device performed between a customer, a BMS, and a cooling unit according to one or more embodiments of the present disclosure;

FIG. 5 is a diagram for describing a procedure for a cooling unit to determine a third control value according to one or more embodiments of the present disclosure;

FIG. 6 is a diagram showing an example of an energy storage device and a cooling unit according to one or more embodiments of the present disclosure;

FIG. 7 is a diagram showing an example of data for calculating a control value of a cooling unit according to one or more embodiments of the present disclosure; and

FIG. 8 is a flowchart for describing a control method for cooling an energy storage device according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her disclosure in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

A “control value” in the present disclosure is a value related to the cooling performance of a cooling unit, and if the control value is higher than other control values, the cooling performance of the cooling unit operating based on the corresponding control value can be relatively high. If the control value is lower than other control values, the cooling performance of the cooling unit operating based on the corresponding control value can be relatively low.

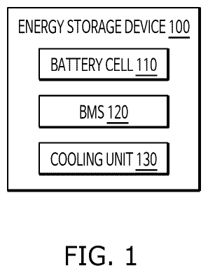

FIG. 1 is a block diagram showing the configuration of an energy storage device 100 according to one or more embodiments of the present disclosure. Referring to FIG. 1, the energy storage device 100 may include battery cells 110, a BMS (battery management system) 120, and a cooling unit 130.

The energy storage device 100 may provide a space that houses the battery cells 110. For example, a plurality of battery cells 110 may be housed in a stacked form inside the frame of a battery module in battery module units. The battery cells 110 may be connected in series or parallel to each other inside a battery module, and battery modules may be connected to each other in a series or parallel connection inside the energy storage device 100.

The energy storage device 100 may include at least one battery module. In one or more embodiments, a plurality of battery modules may be housed in a stacked form inside the frame of a battery pack. In one or more other embodiments, the energy storage device 100 may have a structure in which a plurality of battery cells 110 is stacked in a single cell stack instead of a battery module or battery pack. The cell stack may be housed in an accommodation space of the energy storage device 100 or may be housed in an accommodation space compartmentalized by a frame, partition, etc.

The energy storage device 100 may include the BMS 120 for monitoring the plurality of battery cells. The BMS 120 may include a detection device, a balancing device, and a control device.

The detection device of the BMS 120 may sense the states (voltage, current, temperature, etc.) of the battery and detect state information indicating the states of the battery. The detection device may detect the voltage of each battery cell and/or each battery module constituting the energy storage device 100. Further, the detection device may also detect the current flowing through the battery module. The detection device may also detect the temperature of the battery cells, the battery module, and/or surroundings of the energy storage device 100 at at least one point (e.g., location) of the energy storage device 100.

The balancing device of the BMS 120 may perform a balancing operation of the battery modules and/or battery cells 110 constituting the energy storage device 100.

The control device of the BMS 120 may receive state information (voltage, current, temperature, etc.) of the battery cells 110 and/or the battery module from the detection device. The control device may monitor and calculate the states (voltage, current, temperature, state of charge (SOC), state of health (SOH), etc.) and the like of the battery cells 110 and/or the battery module based on the state information received from the detection device. Further, the control device may also perform control functions (e.g., temperature control, balancing control, charge/discharge control, etc.), protection functions (e.g., over-discharge, over-charge, over-current prevention, short-circuit, fire extinguishing function, etc.) based on the state monitoring results. Moreover, the control device may also perform a wired or wireless communication function with devices external to the energy storage device 100 (e.g., a higher-level controller, a vehicle, a charger, or PCS (Personal Communications Service, e.g., cell or smart phones), etc.).

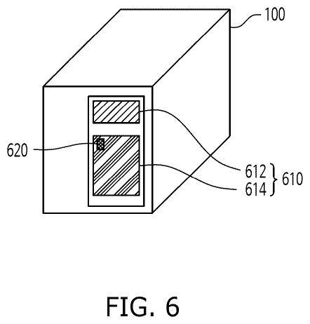

The energy storage device 100 may include the cooling unit 130 that cools the battery cells 110. The battery cells 110 generate a large amount of heat during charging/discharging. The generated heat accumulates in the battery cells 110 and accelerates the deterioration of the battery cells 110. Therefore, the energy storage device 100 includes the cooling unit 130 to suppress the deterioration of the battery cells 110. The cooling unit 130 may include an HVAC (heating, ventilation and air conditioning) unit, a chiller, or the like. An example of a specific configuration of the cooling unit 130 will be described in detail later with reference to FIG. 6.

In one or more embodiments, the BMS 120 may control the cooling unit 130. For example, the BMS 120 may determine a control value for controlling the cooling unit 130. The BMS 120 may calculate a control value for controlling the cooling unit 130 based on the monitoring results for the battery cells 110 inside the energy storage device 100.

Further, the BMS 120 may receive noise limit criteria data associated with the energy storage device 100, and determine a control value for controlling the cooling unit 130 based on the noise limit criteria. For example, a maximum speed control value for the condenser fan of the cooling unit 130 may be calculated based on the noise limit criteria.

Furthermore, the BMS 120 may determine a control value for controlling the cooling unit 130 based on an operable range of the cooling unit 130. For example, the cooling unit 130 may determine whether the control value based on the monitoring result for the battery cells 110 and/or the noise limit criteria is within the operable range of the cooling unit 130, and calculate the control value based on the operable range of the cooling unit 130. Further, the BMS 120 may control the cooling unit 130 based on the control value calculated by the cooling unit 130. Although it has been described that the control value based on the operable range of the cooling unit 130 is calculated by the cooling unit 130, the control value based on the operable range of the cooling unit 130 may also be calculated by the BMS 120.

The configuration of the energy storage device 100 shown in FIG. 1 is merely an example, and in one or more embodiments, other components may be further included in addition to the components shown, and some components may be omitted. If some of the above components are omitted, the functions of the omitted components may be performed by components other than the components shown.

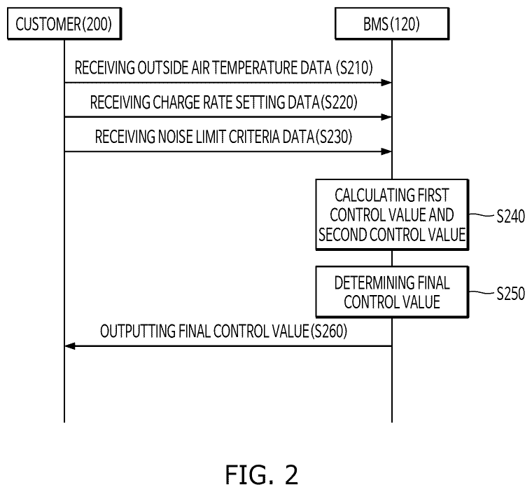

FIG. 2 is a diagram for describing a control method for cooling an energy storage device performed between a customer 200 and a BMS 120 according to one or more embodiments of the present disclosure.

The control method for cooling an energy storage device may begin with the BMS 120 receiving outside air temperature data from the customer 200 (S210). Here, the customer 200 may refer to an operator and/or a task system or the like that oversees the control of the energy storage device, and the BMS 120 may refer to a system that monitors and controls the states of the energy storage device. The outside air temperature data refers to the temperature outside the energy storage device, and the outside air temperature data may be measured in the vicinity of the condenser of the cooling unit included in the energy storage device. The outside air temperature data may include temperature data of the air flowing in through the condenser of the cooling unit. An example in which outside air temperature data is measured will be described in detail later with reference to FIG. 6.

Further, the BMS 120 may receive charge rate setting data from the customer 200 (S220). The charge rate setting data may refer to CP-rate (constant power rate) setting data for the battery cells. For example, the BMS 120 may control a charge rate or discharge rate for the plurality of battery cells included in the energy storage device based on the charge rate setting data received from the customer 200.

Moreover, the BMS 120 may receive noise limit criteria data from the customer 200 (S220). The noise limit criteria (dBA) may vary depending on the target area where the energy storage device is located and the time slot during which noise is generated. For example, if the target area where the energy storage device is located is a residential area, the noise limit criteria may be tightened. Further, if the time slot during which noise is generated is at night, the noise limit criteria may be tightened compared to the daytime.

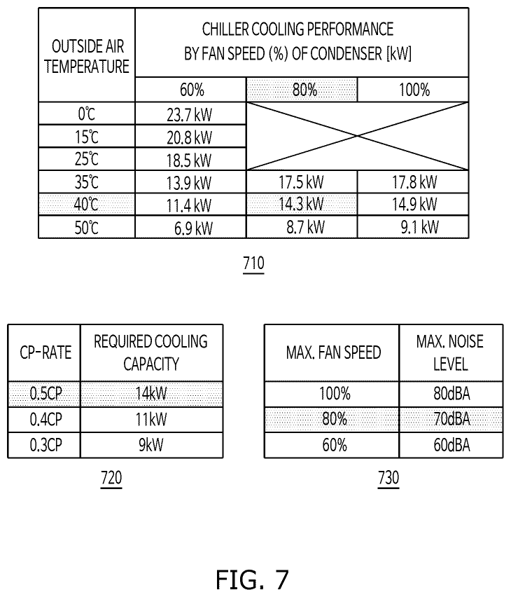

Thereafter, the BMS 120 may calculate a first control value and a second control value for controlling the cooling unit of the energy storage device (S240). Specifically, the BMS 120 may calculate the first control value based on the outside air temperature data and the charge rate setting data received from the customer 200. Here, the first control value may include a maximum speed control value for the condenser fan of the cooling unit, which is required based on the outside air temperature data and the charge rate setting data. Further, the BMS 120 may calculate the second control value based on the noise limit criteria data received from the customer 200. Here, the second control value may include a maximum speed control value for the condenser fan of the cooling unit, which is required based on the noise limit criteria data. An example of calculating the first control value will be described in detail later with reference to FIG. 7.

Thereafter, the BMS 120 may determine a final control value based on the calculated first control value and second control value (S250). As a specific example, the BMS 120 may determine one of the first control value and the second control value as the final control value based on the monitoring results of the battery cells included in the energy storage device. As another example, the BMS 120 may determine a third control value, calculated based on the monitoring results of the battery cells included in the energy storage device and the operable range of the cooling unit of the energy storage device, as the final control value. Here, the third control value may include a maximum speed control value for the condenser fan of the cooling unit, which is calculated based on the operable range of the cooling unit.

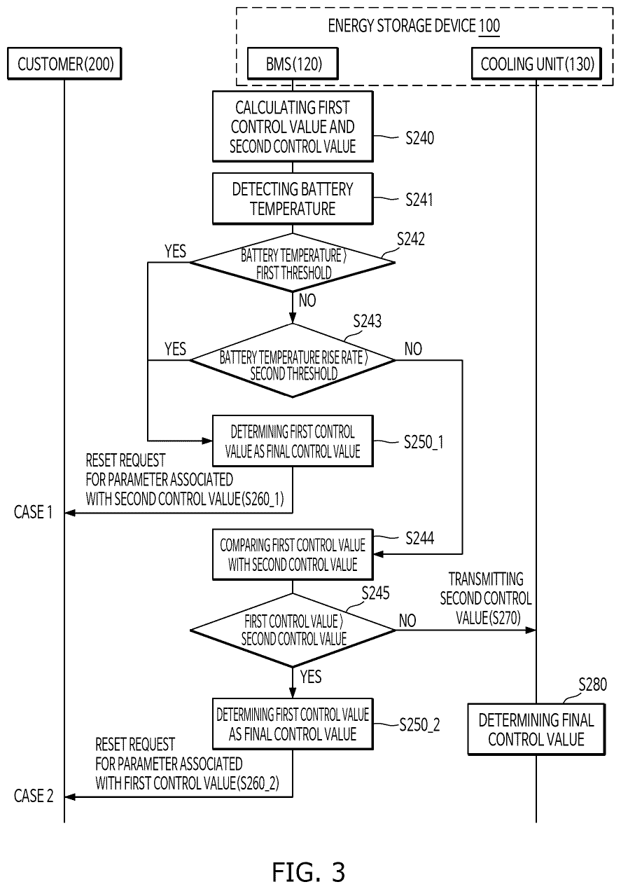

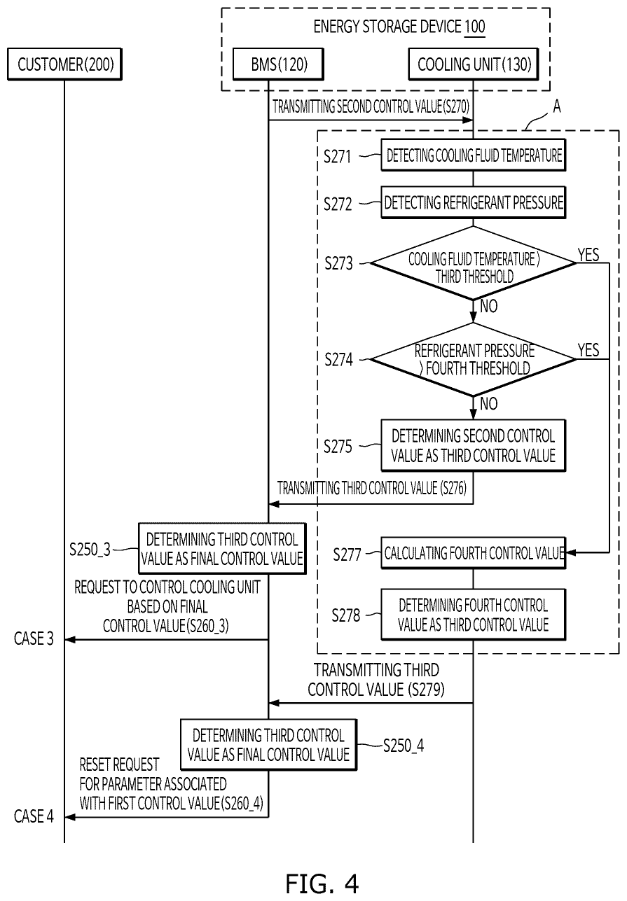

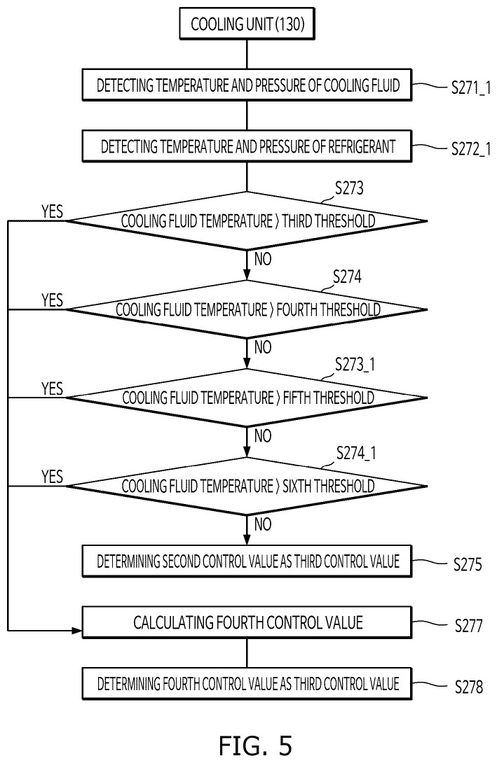

In one or more embodiments, the final control value refers to a control value to be outputted to the customer 200, and the cooling unit is not necessarily controlled based on the final control value. For example, the BMS 120 may output the final control value and, at the same time, output a reset request for a parameter associated with the final control value. An example of determining the final control value based on the first control value and the second control value will be described in detail later with reference to FIG. 3. Further, an example of determining the third control value as the final control value will be described in detail later with reference to FIGS. 4 and 5.

Thereafter, the BMS 120 may output the determined final control value to the customer 200 (S260). The BMS 120 may output a request associated with the control of the cooling unit together, based on the determined final control value. An example of outputting a request associated with the control of the cooling unit together with the final control value will be described in detail later with reference to FIGS. 3 and 4.

In the embodiment described above, it has been described that the BMS 120 receives the outside air temperature data, charge rate setting data, and noise limit criteria data from the customer 200, but the BMS 120 may receive outside air temperature data from a temperature measurement sensor for measuring the temperature outside the energy storage device 100. Or, the BMS 120 may receive charge rate setting data from a sensor that monitors the states of the battery cells of the energy storage device 100. Or, the noise limit criteria data may be preset.

With this configuration, the control method for cooling an energy storage device can minimize noise problems occurring in the neighboring areas where the energy storage device is located as the control value of the cooling unit is determined based not only on the monitoring results of the battery cells but also on the noise limit criteria.

FIG. 3 is a diagram for describing an output procedure of a final control value of a control method for cooling an energy storage device 100 performed between a customer 200, a BMS 120, and a cooling unit 130 according to one or more embodiments of the present disclosure. In FIG. 3, the description of the steps (S210 to S230 in FIG. 2) that are described in FIG. 2 or are otherwise repeated will be omitted, and the procedure between the step of calculating the first control value and the second control value (S240 in FIG. 2) and the step of outputting the final control value (S260 in FIG. 2) will be mainly described.

After calculating the first control value and the second control value, the BMS 120 may detect the temperature of each of the plurality of battery cells included in the energy storage device 100 (S241).

In one or more embodiments, if the temperature of at least one battery cell of the plurality of battery cells exceeds a first threshold, the BMS 120 may determine the first control value as the final control value (S242, S250_1). Likewise, if the temperature rise rate of at least one battery cell of the plurality of battery cells exceeds a second threshold, the BMS 120 may determine the first control value as the final control value (S243, S250_1). For example, if the temperature of at least one of the plurality of battery cells exceeds the first threshold or the temperature rise rate thereof exceeds the second threshold, the first control value based on the monitoring results of the battery cells may be determined as the final control value.

In FIG. 3, it is shown that the BMS 120 compares the temperature of the battery cells with the first threshold and then compares the temperature rise rate of the battery cells with the second threshold only when the temperature of the battery cells is lower than or equal to the first threshold, but the BMS 120 may compare the temperature rise rate of the battery cells with the second threshold and then compare the temperature of the battery cells with the first threshold if the temperature rise rate of the battery cells is lower than or equal to the second threshold. Further, the BMS 120 may perform the procedure of comparing the temperature of the battery cells with the first threshold and the procedure of comparing the temperature rise rate of the battery cells with the second threshold in parallel.

After the first control value is determined as the final control value, the BMS 120 may output the determined final control value to the customer 200. Further, the BMS 120 may output a reset request for a parameter associated with the second control value together, based on the determined final control value (S260_1). For example, the BMS 120 may output the first control value based on the monitoring results of the battery cells as the final control value, and at the same time, request to reset the second control value associated with the noise limit criteria data and/or the parameter associated with the second control value. Accordingly, if it is determined that the battery cells are operating abnormally (e.g., if the temperature of the battery cells exceeds the first threshold or the temperature rise rate exceeds the second threshold), the BMS 120 may request to control the cooling unit 130 regardless of the noise limit criteria.

In one or more other embodiments, if the temperature of each of the plurality of battery cells is lower than or equal to the first threshold and the temperature rise rate is lower than or equal to the second threshold as a result of detecting the temperature of each of the plurality of battery cells included in the energy storage device 100, the BMS 120 may compare the first control value with the second control value (S242, S243, S244). At this time, if it is determined that the first control value exceeds the second control value, the BMS 120 may determine the first control value as the final control value (S245, S250_2). For example, if the first control value exceeds the second control value even if the temperature of each of the plurality of battery cells is lower than or equal to the first threshold and the temperature rise rate is lower than or equal to the second threshold, the first control value may be determined as the final control value.

Further, the BMS 120 may output the determined final control value to the customer 200. Moreover, the BMS 120 may output a reset request for the first control value based on the monitoring results of the battery cells and/or the parameter associated with the first control value together, based on the determined final control value (S260_2). For example, if the noise limit criteria are not satisfied even if the battery cells are determined to be operating normally (e.g., the temperature of the battery cells is lower than or equal to the first threshold and the temperature rise rate is lower than or equal to the second threshold), the BMS 120 may request to reset the parameter associated with the first control value. Accordingly, the customer 200 may take measures such as adjusting the charge rate setting data (e.g., CP-rate) or adjusting the charge/discharge schedule of the energy storage device in order to reset the parameter associated with the first control value.

In yet one or more other embodiments, if the temperature of each of the plurality of battery cells is lower than or equal to the first threshold and the temperature rise rate is lower than or equal to the second threshold as a result of detecting the temperature of each of the plurality of battery cells included in the energy storage device 100, the BMS 120 may compare the first control value with the second control value (S242, S243, S244). At this time, if it is determined that the first control value is lower than or equal to the second control value, the BMS 120 may transmit the second control value to the cooling unit 130 (S245, S270). Thereafter, the cooling unit 130 may determine a third control value based on the received second control value and the operable range of the cooling unit (S280). An example of the step (S280) in which the cooling unit 130 determines the third control value will be described in detail later with reference to FIGS. 4 and 5.

FIG. 4 is a diagram for describing an output procedure of a final control value of a control method for cooling an energy storage device 100 performed between a customer 200, a BMS 120, and a cooling unit 130 according to one or more embodiments of the present disclosure. In FIG. 4, the description of the steps (S210 to S230 in FIG. 2, and S240 to S245 in FIG. 3) that are described in FIGS. 2 and 3 or are otherwise repeated will be omitted, and the procedure between the step of transmitting the second control value (S270 of FIG. 3) and the step of outputting the final control value (S260 of FIG. 2) will be mainly described.

If the temperature of each of the plurality of battery cells is lower than or equal to the first threshold and the temperature rise rate is lower than or equal to the second threshold as a result of detecting the temperature of each of the plurality of battery cells included in the energy storage device 100, the BMS 120 may compare the first control value with the second control value, and if it is determined that the first control value is lower than or equal to the second control value, the BMS 120 may transmit the second control value to the cooling unit 130 (S270).

Thereafter, the cooling unit 130 may detect the outflow temperature of a cooling fluid flowing through a cooling flow path in order to cool the plurality of battery cells (S271). Further, the cooling unit 130 may detect the pressure of a refrigerant that cools the discharged cooling fluid (S272).

In one or more embodiments, if the outflow temperature of the cooling fluid is lower than or equal to a third threshold and the pressure of the refrigerant is lower than or equal to a fourth threshold, the cooling unit 130 may determine the second control value as a third control value (S273, S274, S275). Further, the cooling unit 130 may transmit the determined third control value to the BMS 120 (S276). Here, the third threshold and the fourth threshold may be calculated based on the second control value transmitted from the BMS 120, the performance of the cooling unit, the operable range of the cooling unit, etc.

Thereafter, the BMS 120 may determine the received third control value as the final control value (S250_3). For example, if it is determined that the second control value calculated based on the noise limit criteria is within the operable range of the cooling unit 130 (e.g., if the outflow temperature of the cooling fluid is lower than or equal to the third threshold and the pressure of the refrigerant is lower than or equal to the fourth threshold) as a result of monitoring the cooling unit 130, the cooling unit 130 may determine the second control value as the third control value, and the BMS 120 may determine the determined third control value as the final control value.

Further, the BMS 120 may output the determined final control value to the customer 200. Moreover, the BMS 120 may output a request to control the cooling unit together, based on the determined final control value (S260_3). For example, the BMS 120 may request to control the cooling unit 130 based on the determined final control value if it is determined that the determined final control value satisfies the noise limit criteria and, at the same time, is within the operable range of the cooling unit 130.

In one or more other embodiments, if the outflow temperature of the cooling fluid exceeds the third threshold, the cooling unit 130 may calculate a fourth control value based on the outflow temperature of the cooling fluid (S273, S277). Likewise, if the pressure of the refrigerant exceeds the fourth threshold, the cooling unit 130 may calculate the fourth control value based on the pressure of the refrigerant (S274, S277). For example, if the outflow temperature of the cooling fluid exceeds the third threshold or the pressure of the refrigerant exceeds the fourth threshold, the cooling unit 130 may calculate the fourth control value based on the operable range of the cooling unit 130. Thereafter, the cooling unit 130 may determine the calculated fourth control value as the third control value (S278).

In FIG. 4, it is shown that the cooling unit 130 compares the outflow temperature of the cooling fluid with the third threshold, and then compares the pressure of the refrigerant with the fourth threshold only when the outflow temperature of the cooling fluid is lower than or equal to the third threshold, but the cooling unit 130 may compare the pressure of the refrigerant with the fourth threshold, and then compare the outflow temperature of the cooling fluid with the third threshold if the pressure of the refrigerant is lower than or equal to the fourth threshold. Further, the cooling unit 130 may perform the procedure of comparing the outflow temperature of the cooling fluid with the third threshold and the procedure of comparing the pressure of the refrigerant with the fourth threshold in parallel.

After the third control value is determined, the cooling unit 130 may transmit the determined third control value to the BMS 120 (S279). Thereafter, the BMS 120 may determine the determined third control value as the final control value (S250_4). For example, if it is determined that the second control value calculated based on the noise limit criteria falls outside the operable range of the cooling unit 130 (e.g., if the outflow temperature of the cooling fluid exceeds the third threshold or the pressure of the refrigerant exceeds the fourth threshold) as a result of monitoring the cooling unit 130, the cooling unit 130 may determine the fourth control value calculated based on the operable range of the cooling unit as the third control value, and the BMS 120 may determine the determined third control value as the final control value.

Further, the BMS 120 may output the determined final control value to the customer 200. Moreover, the BMS 120 may output a reset request for the parameter associated with the first control value together, based on the determined final control value (S260_4). For example, if it is determined that the determined final control value falls outside the operable range of the cooling unit 130 even though it satisfies the noise limit criteria, the BMS 120 may request to reset the parameter associated with the first control value. Accordingly, the customer 200 may take measures such as adjusting the charge rate setting data (e.g., CP-rate) or adjusting the charge/discharge schedule of the energy storage device in order to reset the parameter associated with the first control value.

With this configuration, the cooling unit can be operated efficiently through a procedure in which whether the control value calculated based on the monitoring results of the battery cells and the noise limit criteria is within the operable range of the cooling unit is fed back.

In the present disclosure, at least some of the steps performed by the cooling unit 130 may be performed by the BMS 120. For instance, in relation to the step of determining the final control value (S280), the step of calculating the control value based on the cooling fluid temperature and/or the refrigerant pressure (e.g., S275 to S278) may be performed by the BMS 120. At this time, the data on the cooling fluid temperature and/or the refrigerant pressure may be detected by the cooling unit 130, and the cooling unit 130 may transmit the corresponding data to the BMS 120.

FIG. 5 is a diagram for describing a procedure for a cooling unit 130 to determine a third control value according to one or more embodiments of the present disclosure. For reference, additional embodiments associated with the steps included in the highlighted area A in FIG. 4 will be described in FIG. 5.

The cooling unit 130 may detect the outflow temperature and pressure of the cooling fluid flowing through the cooling flow path in order to cool the plurality of battery cells (S271_1). Further, the cooling unit 130 may detect the temperature and pressure of the refrigerant that cools the discharged cooling fluid (S272). For example, the cooling unit 130 may further detect at least one of the pressure of the cooling fluid or the temperature of the refrigerant, compared to the embodiment of FIG. 4.

In one or more embodiments, if the outflow temperature of the cooling fluid is lower than or equal to the third threshold, the pressure of the refrigerant is lower than or equal to the fourth threshold, the pressure of the cooling fluid is lower than or equal to a fifth threshold, and the temperature of the refrigerant is lower than or equal to a sixth threshold, the cooling unit 130 may determine the second control value as the third control value (S273, S274, S273_1, S274_1, S275). For example, if it is determined that the second control value calculated based on the noise limit criteria is within the operable range of the cooling unit 130 (e.g., if the outflow temperature of the cooling fluid is lower than or equal to the third threshold, the pressure of the refrigerant is lower than or equal to the fourth threshold, the pressure of the cooling fluid is lower than or equal to the fifth threshold, and the temperature of the refrigerant is lower than or equal to the sixth threshold) as a result of monitoring the cooling unit 130, the cooling unit 130 may determine the second control value as the third control value, and the BMS 120 may determine the determined third control value as the final control value.

In one or more other embodiments, if the outflow temperature of the cooling fluid exceeds the third threshold, the cooling unit 130 may calculate a fourth control value based on the outflow temperature of the cooling fluid (S273, S277). Likewise, if the pressure of the refrigerant exceeds the fourth threshold, the cooling unit 130 may calculate the fourth control value based on the pressure of the refrigerant (S274, S277). Further, if the pressure of the cooling fluid exceeds the fifth threshold or the temperature of the refrigerant exceeds the sixth threshold, the cooling unit 130 may calculate the fourth control value based on at least one of the pressure of the cooling fluid or the temperature of the refrigerant (S273_1, S274_1, S275). For example, if it is determined that the second control value calculated based on the noise limit criteria falls outside the operable range of the cooling unit 130 (e.g., if the outflow temperature of the cooling fluid exceeds the third threshold, the pressure of the refrigerant exceeds the fourth threshold, the pressure of the cooling fluid exceeds the fifth threshold, or the temperature of the refrigerant exceeds the fifth threshold) as a result of monitoring the cooling unit 130, the cooling unit 130 may calculate the fourth control value based on the operable range of the cooling unit 130. Thereafter, the cooling unit 130 may determine the calculated fourth control value as the third control value (S278).

FIG. 6 is a diagram showing an example of an energy storage device 100 and a cooling unit according to one or more embodiments of the present disclosure. In one or more embodiments, the energy storage device 100 may include a cooling unit (e.g., 130 in FIG. 1). The cooling unit can cool a plurality of battery cells included in the energy storage device 100.

The cooling unit may include a cooling plate (not shown) that cools the battery cells through heat exchange with the battery cells. A cooling flow path for the flow of a cooling fluid may be formed inside the cooling plate. The cooling fluid may include liquid cooling water or gaseous cooling air. The cooling plate may be provided at the bottom of a battery cell accommodation space but may also be provided at the top or sides of the battery cells depending on the structure of the energy storage device.

In one or more embodiments, the cooling unit may cool a refrigerant through a cooling cycle of the refrigerant to absorb the heat of the cooling fluid. The cooling cycle of the refrigerant may be performed by an evaporator, a compressor, a condenser 610, an expansion valve, etc. For example, the evaporator can absorb the heat of the cooling fluid while evaporating the refrigerant into a gaseous state. The compressor can compress the gaseous refrigerant into a high-pressure gas. The condenser 610 may allow the refrigerant to release heat through heat exchange with the outside air while condensing the high-pressure gaseous refrigerant into a liquid. The expansion valve can depressurize the liquid refrigerant and transfer it to the evaporator.

In one or more embodiments, the condenser 610 of the cooling unit may be disposed in an outward direction of the energy storage device 100. The condenser 610 may include an air outlet 612, an air inlet 614, and a condenser fan for heat exchange between the refrigerant and the outside air. Heat exchange between the outside air introduced through the air inlet 614 as the condenser fan rotates and the refrigerant may be carried out. At this time, noise may be generated as the condenser fan rotates, and the larger the heat capacity required for cooling the battery cells, the higher the rotation speed of the condenser fan gets, causing louder noise.

In one or more embodiments, a temperature and humidity sensor 620 for detecting outside air temperature data may be installed near the air inlet 614 of the condenser 610. The outside air temperature data detected by the temperature and humidity sensor 620 may be transmitted to the BMS of the energy storage device 100. Further, the BMS may determine a control value for controlling the cooling unit based on the received outside air temperature data. At this time, by having the outside air temperature data detected near the air inlet 614 of the condenser 610, the BMS may calculate a more accurate control value.

FIG. 7 includes tables showing an example of data for calculating a control value of a cooling unit according to one or more embodiments of the present disclosure. A first table 710, a second table 720, and a third table 730 are examples of data used for calculating a first control value. The first table 710 may show an example of a cooling capacity according to the outside air temperature and the rotation speed (%) of a condenser fan. The second table 720 may show an example of a cooling capacity required according to the charge rate setting data (e.g., CP-rate) of the energy storage device. The third table 730 may show an example of the magnitude of noise (dBA) generated according to the rotation speed (%) of the condenser fan.

As a specific example, suppose that the outside air temperature detected near the condenser is 40 [symbol] C and the charge rate of the energy storage device is set to 0.5 CP. In this case, the cooling capacity required for cooling the energy storage device may be calculated to be 14 kW (see the second table 720), and a control value associated with the rotation speed of the condenser fan may be calculated to be 80% in order for the condenser of the cooling unit to exhibit cooling performance greater than or equal to the calculated cooling capacity (see the first table 710). In this case, it can be confirmed that the noise generated by the rotation of the condenser fan is 70 dBA (see Table 3 730).

In one or more embodiments, the data (e.g., 710 to 730) for calculating the control value of the cooling unit may be inputted in advance to the BMS and/or the cooling unit, and the BMS and/or the cooling unit may determine the control value for controlling the cooling unit based on this data.

The data described above is merely one example, and may vary depending on the performance of the cooling unit, the size of the energy storage device, etc. The method of calculating the control value of the cooling unit described above is also merely one example, but the method used may vary.

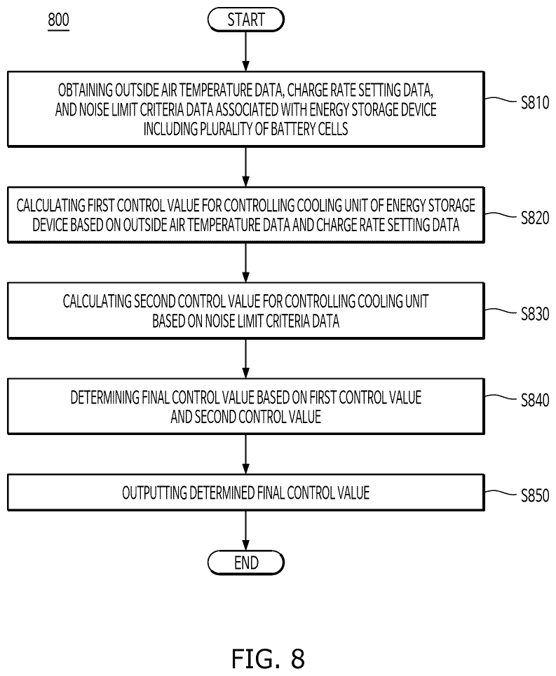

FIG. 8 is a flowchart for describing a control method 800 for cooling an energy storage device according to one or more embodiments of the present disclosure. The control method 800 may begin with a battery management system (BMS) obtaining outside air temperature data, charge rate setting data, and noise limit criteria data associated with an energy storage device including a plurality of battery cells (S810). At this time, the outside air temperature data may be measured near a condenser of a cooling unit.

Next, the BMS may calculate a first control value for controlling the cooling unit of the energy storage device based on the outside air temperature data and the charge rate setting data (S820). Here, the first control value may include a maximum speed control value for a condenser fan included in the cooling unit. Further, the BMS may calculate a second control value for controlling the cooling unit based on the noise limit criteria data (S830).

Next, the BMS may determine a final control value based on the first control value and the second control value (S840). Further, the BMS may output the determined final control value (S850). The determining the final control value may include detecting the temperature of each of the plurality of battery cells included in the energy storage device.

In one or more embodiments, if the temperature of at least one battery cell of the plurality of battery cells exceeds a first threshold or the rise rate of the temperature exceeds a second threshold, the BMS may determine the first control value as the final control value and output the final control value to the customer. Further, a reset request for a parameter associated with the second control value may be outputted.

In other embodiments, if the temperature of each of the plurality of batteries is lower than or equal to the first threshold and the rise rate of the temperature is lower than or equal to the second threshold, the BMS may compare the first control value with the second control value. At this time, if it is determined that the first control value exceeds the second control value, the first control value may be determined as the final control value and the final control value may be outputted to the customer. Further, a reset request for a parameter associated with the first control value may be outputted.

In yet other embodiments, if the temperature of each of the plurality of batteries is lower than or equal to the first threshold and the rise rate of the temperature is lower than or equal to the second threshold, the BMS may compare the first control value with the second control value, and if it is determined that the first control value is lower than or equal to the second control value, the second control value may be transmitted to the cooling unit. Thereafter, the cooling unit may determine a third control value based on the second control value and the operable range of the cooling unit. Moreover, the BMS may determine the third control value as the final control value.

At this time, the determining the third control value may include detecting an outflow temperature of a cooling fluid flowing through a cooling flow path of the cooling unit and detecting a pressure of a refrigerant that cools the cooling fluid in a condenser of the cooling unit. Further, the determining the third control value may further include at least one of detecting a temperature rise rate of the cooling fluid or detecting a temperature of the refrigerant.

In one or more embodiments, if the outflow temperature of the cooling fluid is lower than or equal to a third threshold and the pressure of the refrigerant is lower than or equal to a fourth threshold, the cooling unit may determine the second control value as the third control value. In this case, the BMS may determine the third control value as the final control value and output the final control value to the customer. Further, a control request for the cooling unit may be outputted based on the final control value.

In other embodiments, if the outflow temperature of the cooling fluid exceeds the third threshold or the pressure of the refrigerant exceeds the fourth threshold, the cooling unit may calculate a fourth control value based on the outflow temperature of the cooling fluid and the pressure of the refrigerant, and determine the calculated fourth control value as the third control value. In this case, the BMS may determine the third control value as the final control value and output the final control value to the customer. Further, a reset request for a parameter associated with the second control value may be outputted.

The flowchart in FIG. 8 and the foregoing description are merely examples of the present disclosure, and the scope of the present disclosure is not limited to the flowchart in FIG. 8 and the foregoing description. For example, one or more steps in the flowchart and the foregoing description may be added/modified/deleted, the order of one or more steps may be changed, and one or more steps may be performed simultaneously.

An energy storage device refers to a device or system that stores electrical energy so that it can be used when needed. The energy storage device includes a plurality of secondary batteries and allows for coping with variability in electrical energy, etc. Further, the energy storage device may include a cooling unit for cooling the heat generated during the charging and discharging of the secondary batteries. At this time, noise may be generated from the condenser fan of the cooling unit, which may cause noise problems in the neighboring areas where the energy storage device is located.

The problem to be solved by the present disclosure is to provide an energy storage device and a control method for cooling the energy storage device to solve the above problem.

According to one or more embodiments of the present disclosure, noise problems occurring in the neighboring areas where the energy storage device is located can be minimized as the control value of the cooling unit is determined based not only on the monitoring results of the battery cells but also on the noise limit criteria.

According to one or more embodiments of the present disclosure, the cooling unit can be operated efficiently through a procedure in which whether the control value calculated based on the monitoring results of the battery cells and the noise limit criteria is within the operable range of the cooling unit is fed back.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SOME REFERENCE SYMBOLS

100: Energy storage device
110: Battery cells
120: BMS
130: Cooling unit

What is claimed is:

1. A control method for cooling an energy storage device, the control method comprising:
obtaining, by a battery management system (BMS), outside air temperature data, charge rate setting data, and noise limit criteria data associated with an energy storage device comprising a plurality of battery cells;
calculating, by the BMS, a first control value for controlling a cooling unit of the energy storage device based on the outside air temperature data and the charge rate setting data;
calculating, by the BMS, a second control value for controlling the cooling unit based on the noise limit criteria data;
determining, by the BMS, a final control value based on the first control value and the second control value; and
outputting, by the BMS, the determined final control value.

2. The control method for cooling an energy storage device as claimed in claim 1, wherein determining the final control value comprises:
detecting a temperature of each of the plurality of battery cells included in the energy storage device; and
determining the first control value as the final control value if a temperature of at least one battery cell of the plurality of battery cells exceeds a first threshold or a rise rate of the temperature exceeds a second threshold.

3. The control method for cooling an energy storage device as claimed in claim 2, wherein outputting the final control value comprises outputting a reset request for a parameter associated with the second control value.

4. The control method for cooling an energy storage device as claimed in claim 1, wherein determining the final control value comprises:
detecting a temperature of each of the plurality of battery cells included in the energy storage device;
comparing the first control value with the second control value if the temperature of each of the plurality of battery cells is lower than or equal to a first threshold and a rise rate of the temperature is lower than or equal to a second threshold; and
determining the first control value as the final control value if it is determined that the first control value exceeds the second control value.

5. The control method for cooling an energy storage device as claimed in claim 4, wherein outputting the final control value comprises outputting a reset request for a parameter associated with the first control value.

6. The control method for cooling an energy storage device as claimed in claim 4, wherein determining the final control value further comprises:
transmitting, by the BMS, the second control value to the cooling unit if it is determined that the first control value is lower than or equal to the second control value;
determining, by the cooling unit, a third control value based on the second control value and an operable range of the cooling unit; and
determining, by the BMS, the third control value as the final control value.

7. The control method for cooling an energy storage device as claimed in claim 6, wherein determining the third control value comprises:
detecting an outflow temperature of a cooling fluid flowing through a cooling flow path of the cooling unit;
detecting a pressure of a refrigerant cooling the cooling fluid in a condenser of the cooling unit; and
determining the second control value as the third control value if the outflow temperature of the cooling fluid is lower than or equal to a third threshold and the pressure of the refrigerant is lower than or equal to a fourth threshold.

8. The control method for cooling an energy storage device as claimed in claim 7, wherein outputting the final control value comprises outputting a control request for the cooling unit based on the final control value.

9. The control method for cooling an energy storage device as claimed in claim 7, wherein determining the third control value further comprises:
calculating a fourth control value based on the outflow temperature of the cooling fluid and the pressure of the refrigerant if the outflow temperature of the cooling fluid exceeds the third threshold or the pressure of the refrigerant exceeds the fourth threshold; and
determining the fourth control value as the third control value.

10. The control method for cooling an energy storage device as claimed in claim 9, wherein outputting the final control value comprises outputting a reset request for a parameter associated with the first control value.

11. The control method for cooling an energy storage device as claimed in claim 7, wherein determining the third control value further comprises at least one of:
detecting a temperature rise rate of the cooling fluid; and
detecting a temperature of the refrigerant.

12. The control method for cooling an energy storage device as claimed in claim 1, wherein the first control value comprises a maximum speed control value for a condenser fan included in the cooling unit.

13. The control method for cooling an energy storage device as claimed in claim 1, wherein the outside air temperature data is measured near a condenser of the cooling unit.

14. An energy storage device, comprising:
a plurality of battery cells;
a cooling unit configured to cool the plurality of battery cells; and
a BMS configured to control the cooling unit,
wherein the BMS is configured to:
obtain outside air temperature data, charge rate setting data, and noise limit criteria data associated with an energy storage device,
calculate a first control value for controlling the cooling unit based on the outside air temperature data and the charge rate setting data,
calculate a second control value for controlling the cooling unit based on the noise limit criteria data,
determine a final control value based on the first control value and the second control value, and
output the final control value.

15. The energy storage device as claimed in claim 14, wherein determining the final control value comprises:
detecting, by the BMS, a temperature of each of the plurality of battery cells, and
determining, by the BMS, the first control value as the final control value if a temperature of at least one battery cell of the plurality of battery cells exceeds a first threshold or a rise rate of the temperature exceeds a second threshold.

16. The energy storage device as claimed in claim 14, wherein determining the final control value comprises:
detecting, by the BMS, a temperature of each of the plurality of battery cells,
comparing, by the BMS, the first control value with the second control value if the temperature of each of the plurality of battery cells is lower than or equal to a first threshold and a rise rate of the temperature is lower than or equal to a second threshold, and
determining, by the BMS, the first control value as the final control value if it is determined that the first control value exceeds the second control value.

17. The energy storage device as claimed in claim 16, wherein determining the final control value further comprises:
transmitting, by the BMS, the second control value to the cooling unit if it is determined that the first control value is lower than or equal to the second control value,
determining, by the cooling unit, a third control value based on the second control value and an operable range of the cooling unit, and
determining, by the BMS, the third control value as the final control value.

18. The energy storage device as claimed in claim 17, wherein determining the third control value comprises:
detecting, by the cooling unit, an outflow temperature of a cooling fluid flowing through a cooling flow path of the cooling unit,
detecting, by the cooling unit, a pressure of a refrigerant cooling the cooling fluid in a condenser of the cooling unit, and
determining, by the cooling unit, the second control value as the third control value if the outflow temperature of the cooling fluid is lower than or equal to a third threshold and the pressure of the refrigerant is lower than or equal to a fourth threshold.

19. The energy storage device as claimed in claim 18, wherein determining the third control value further comprises:
calculating, by the cooling unit, a fourth control value based on the outflow temperature of the cooling fluid and the pressure of the refrigerant if the outflow temperature of the cooling fluid exceeds the third threshold or the pressure of the refrigerant exceeds the fourth threshold, and
determining, by the cooling unit, the fourth control value as the third control value.

20. The energy storage device as claimed in claim 18, wherein determining the third control value further comprises at least one of:
detecting, by the cooling unit, a temperature rise rate of the cooling fluid, and
detecting, by the cooling unit, a temperature of the refrigerant.
